(19) United States
(12) Patent Application Publication
(10) Pub. No.: US 2005/0286267 A1
(43) Pub. Date: Dec. 29, 2005

(54) Auto-contact bulb assembly

(76) Inventor: Jung Kuei Wang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/878,027

(22) Filed: Jun. 29, 2004

(51) Int. Cl. H01R 33/00

(52) U.S. Cl. 362/653; 362/655

(57) ABSTRACT

An auto-contact bulb assembly includes a shell, a bulb holder connecting with a bulb. An isolated connector connecting with an elastic slice is provided in the shell. The elastic slice can connect with two conductive pins received in the shell for electrical connection of the light string when a broken bulb is removed from the shell with the connecting holder. Hence, the light string can keep the shining decorative effect in ease.

### BACKGROUND OF THE INVENTION

A conventional light string includes main electrical wire, which connects with many bulb assemblies in series. If one of the bulb assemblies is broken, the light string will be worked out either. The decorative effect is certainly lost. There is another structure of the light string connecting with bulb assemblies in parallel for preventing from the above drawback. But the structure is complex and the needed power is too high that is not utilized for use.

### SUMMARY OF THE INVENTION

The present invention is to provide an auto-contact bulb assembly of a light string, wherein the bulb of the bulb assembly can be removed easily as it is broken. And the electrical circuit of the light string will be recovery that other bulb assemblies on the string can lighten for shining decorative purpose. Now, accompanying with the following drawings, the character of the present invention will be described here and after.

### BRIEF DESCRIPTION OF THE DRAWINGS

FIG. 1 is a cross-sectional plan view showing a bulb assembly according to the present invention.

FIG. 2 is an exploded view of FIG. 1.

FIG. 3 is a cross-sectional plan view showing another embodiment of a bulb assembly according to the present invention.

FIG. 4 is a perspective view showing a conductive pin of FIG. 3.

### DETAILED DESCRIPTION OF THE PREFERRED EMBODIMENT

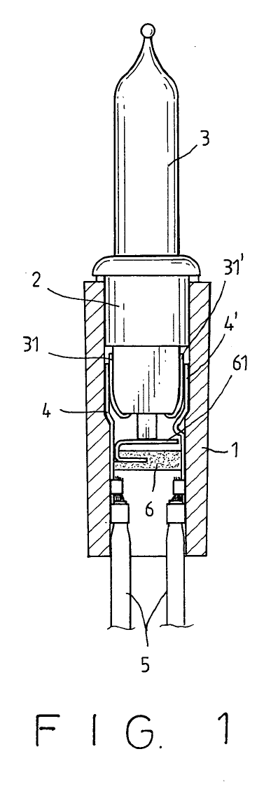

Please referring to FIG. 1, the present invention relates to an improvement of a bulb assembly of a light string. The bulb assembly includes a shell (1) and a bulb holder (2) connecting with a bulb (3). The bulb (3) has its two conductive legs (31), (31′) to contact with respective conductive pins (4), (4′) received in both sides of the shell (1). The conductive pins (4), (4′) are connected with electrical wire (5) of the light string. The characteristic of the present invention is to provide an isolated connector (6) in the shell (1), wherein the connector (6) connects with an elastic slice (61) being contacted with the conductive pin (4) always. As the bulb holder (2) is received in the shell (1), bottom end of the holder (2) presses the elastic slice (61), which has its free end away from the other conductive pin (4′). At this time, the bulb assembly keeps the function for normal use.

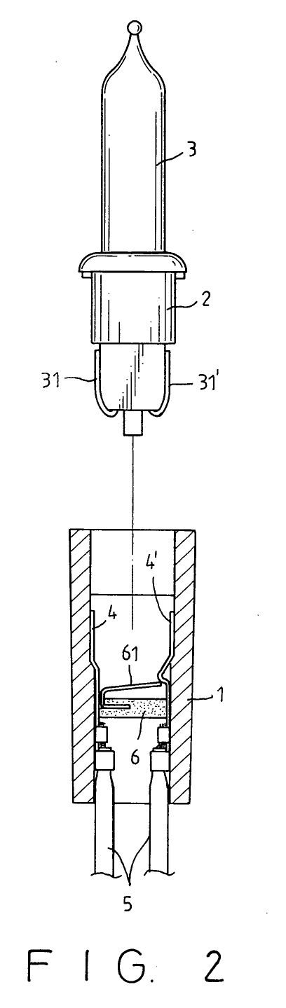

As the bulb (3) is burn out and broken, the present invention can keep the light string working by just removing the holder (2) with the broken bulb (3) from the shell (1). The elastic slice (61) can move upward to contact its free end with the conductive pin (4′), as shown in FIG. 2. Hence, the circuit of the light string is completed again for lightening other bulb assemblies to keep the decorative purpose without replacement of the bulb.

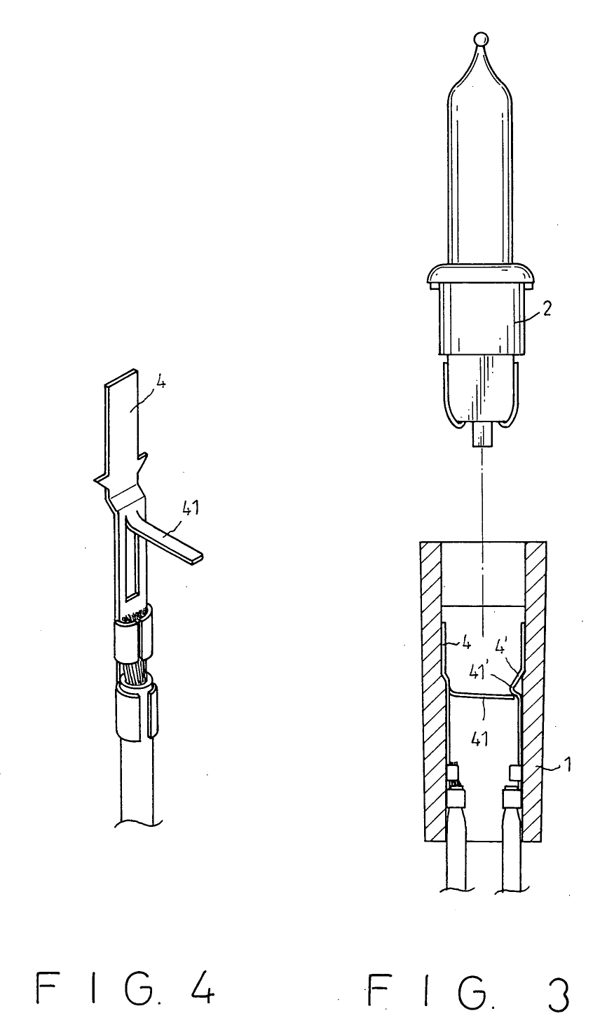

Please referring to FIGS. 3 and 4, it shows another embodiment of the present invention. It provides a conductive pin (4) with an elastic piece (41) having similar function of the elastic slice (61). When the holder (2) is received in the shell (1), the elastic piece (61) is pressed downward and not to contact with the other conductive pin (4′). And when the holder (2) is removed from the shell (1), the elastic piece (41) of the conductive pin (4) elastically moves back to contact with a folded portion (41′) of the conductive pin (4′) to keep the electrical connection of the light string. It overcomes the drawback of the prior structure and obtains improvement and utilization.

1. An auto-contact bulb assembly including a shell and a bulb holder connecting with a bulb having its two conductive legs to contact with respective conductive pins received in both sides of the shell, the conductive pins being connected with electrical wire of the light string, and the improvement is to provide an isolated connector in the shell, wherein the connector connects with an elastic slice being contacted with a conductive pin and having its free end to contact with the other conductive pin for electrical connection of the light string when the holder with the broken bulb is removed.

2. The auto-contact bulb assembly as claimed in claim 1, wherein a conductive pin is provided with an elastic piece for contact with the other conductive pin for electrical connection.
